(19) United States
(12) Patent Application Publication
(10) Pub. No.: US 2009/0100378 A1
(43) Pub. Date: Apr. 16, 2009

(54) SYSTEM AND METHOD FOR ALTERNATIVELY COMMUNICATING WITH AN IM CONTACT USING ADDRESS BOOK VERBS

(76) Inventors: Gerhard Dietrich Klassen, Waterloo (CA); Shaul Serge Wisebourt, Waterloo (CA); Samer Fahmy, Waterloo (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/870,044

(22) Filed: Oct. 10, 2007

(51) Int. Cl. G06F 3/048; G06F 7/06; G06F 17/30

(52) U.S. Cl. 715/821; 707/5; 707/E17.016

(57) ABSTRACT

A system and method for alternatively communicating with an Instant Messaging (IM) contact from an IM application using address book verbs is provided. In an IM application, a context sensitive menu of options is presented to permit a user to invoke alternative communication capabilities (e.g. email, voice, SMS, etc.) of the communication device with the IM contact. Address book contact information stored separately from the IM application is pulled for the IM contact and, for available alternative contact information, respective actions are presented as options (e.g. ‘Call contact’, ‘Email contact’, ‘SMS contact’, etc.). If particular contact information (e.g. phone number is not available) associated alternative communication actions are not presented. Selection of an action invokes the associated alternative application with the appropriate contact information from the IM application.

### FIELD

The present application relates generally to the user interface for an instant messaging (IM) messaging application and more particularly for a system and method for adding address book verbs to the IM application menus.

### BACKGROUND

Communication devices such as personal computers, wireless mobile telephones, personal data assistants, etc. often provide data communication abilities to users. One currently popular form of such communication is Instant Messaging or IM facilitated by an IM application having a graphical user interface (GUI) whereby two or more users of different communication devices can engage in a conversational data communication exchange.

To permit IM message exchange, a user may invite another to agree to receive IM messages and be included in the user's list of IM contacts (sometimes called an IM friend or buddy in view of the agreement to be a potential IM message recipient). The availability of the user or particular IM contacts for conversations may be maintained in accordance with respective presence information. To begin an IM conversation, a user selects a buddy represented by a IM contact list entry of a list of contacts and inputs a message. Additional IM contacts may be invited to engage in a group message, as desired. While IM messaging was originally directed to text, newer protocols support file transports and voice over data communications.

In addition to conducting an IM conversation with a buddy, an IM user may want to communicate with the buddy using another available communication ability provided by the communication device such as phone, email, text messaging, etc. Contact information such as phone numbers, email addresses, etc. for these communication abilities for the buddy may have been previously entered and stored in an address book application by the user. Finding and invoking the buddy's address book contact information for the particular communication ability may be time consuming and difficult. The user typically must switch applications and leave the IM application interface. Exiting and invoking the address book interface or other communication ability interface may be inconvenient and time consuming, requiring a number of user inputs.

Thus it is desirable to provide an IM interface to other communication abilities that can be used to contact the other user.

### BRIEF DESCRIPTION OF THE DRAWINGS

In order that the subject matter may be readily understood, embodiments are illustrated by way of examples in the accompanying drawings, in which:

FIG. 1 is a block diagram which illustrates pertinent components of an example wireless communication network and a mobile station which communicates within this network;

FIG. 2 is a more detailed diagram of the mobile station which may communicate within the wireless communication network;

FIGS. 3A and 3B are representative GUI display views of an address book contact record;

FIG. 4 is a representative GUI display view of an embodiment of an IM application showing an IM contact list;

FIG. 5 is a representative GUI display view of an embodiment of an IM application showing an IM conversation interface;

FIG. 6 is a representative GUI display view, in accordance with the respective embodiment of FIG. 4, showing a menu interface adapted to use the system and method for adding address book verbs to the IM application menus;

FIG. 7 is a representative GUI display view, in accordance with the respective embodiment of FIG. 5, showing a menu interface adapted to use the system and method for adding address book verbs to the IM application menus;

FIG. 8 is a flow chart showing the operations for using the system and method for adding address book verbs to the IM application menus with an IM application in accordance with an embodiment;

FIG. 9 is a flow chart showing the operations for finding the selected IM contact's address book information and preparing the associated address book verbs, in accordance with the embodiment of FIG. 8; and

FIG. 10 is a block diagram of a portion of memory showing components of an IM application using the system and method for adding address book verbs to IM application menus in accordance with an embodiment.

### DETAILED DESCRIPTION

Persons of ordinary skill in the art will appreciate that the teachings herein are applicable to messages received via wired or wireless communication and though a wireless communication device and network including wireless communication capabilities are discussed in the examples, no limitations should be imposed.

A system and method for alternatively communicating with an Instant Messaging (IM) contact from an IM application using address book verbs is provided. In an IM application, a context sensitive menu of options is presented to permit a user to invoke alternative communication capabilities (e.g. email, voice, SMS, etc.) of the communication device with the IM contact. Address book contact information stored separately from the IM application is pulled for the IM contact and, for available alternative contact information, respective actions are presented as options (e.g. ‘Call contact’, ‘Email contact’, ‘SMS contact’, etc.). If particular contact information (e.g. phone number is not available) associated alternative communication actions are not presented. Selection of an action invokes the associated alternative application with the appropriate contact information from the IM application.

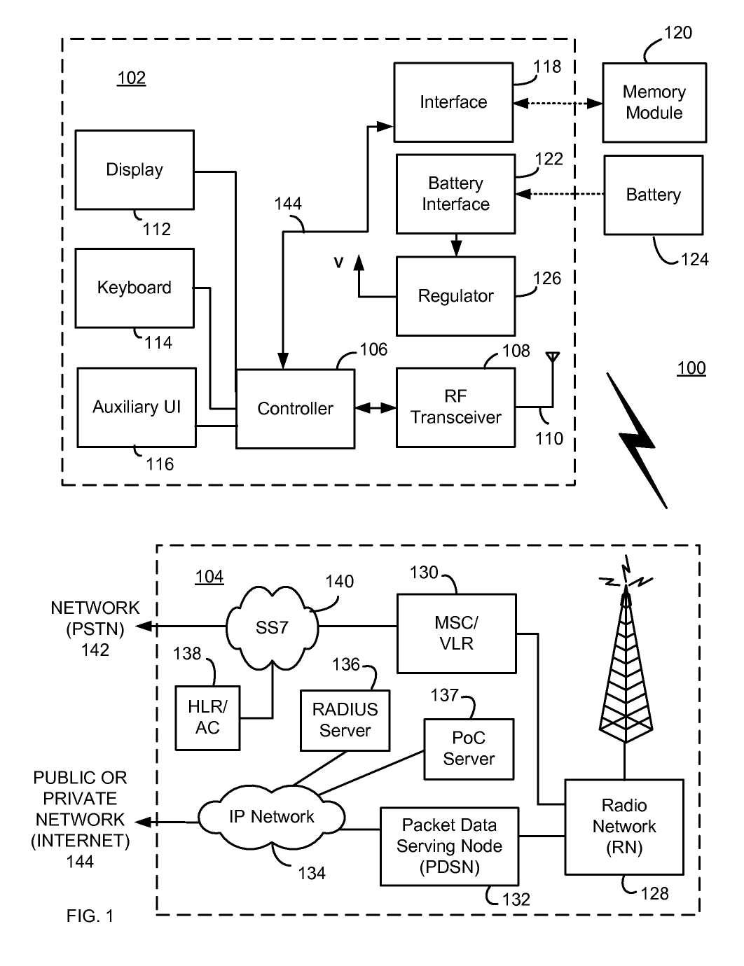

FIG. 1 is a block diagram of a communication system 100 which includes a mobile station 102 which communicates through a wireless communication network 104. Mobile station 102 preferably includes a visual display 112, a keyboard 114, and perhaps one or more auxiliary user interfaces (UI) 116, each of which is coupled to a controller 106. Controller 106 is also coupled to radio frequency (RF) transceiver circuitry 108 and an antenna 110.

Typically, controller 106 is embodied as a central processing unit (CPU) which runs operating system software in a memory component (not shown). Controller 106 will normally control overall operation of mobile station 102, whereas signal processing operations associated with communication functions are typically performed in RF transceiver circuitry 108. Controller 106 interfaces with device display 112 to display received information, stored information, user inputs, and the like. Keyboard 114, which may be a telephone type keypad or full alphanumeric keyboard, is normally provided for entering data for storage in mobile station 102, information for transmission to network 104, a telephone number to place a telephone call, commands to be executed on mobile station 102, and possibly other or different user inputs.

Mobile station 102 sends communication signals to and receives communication signals from network 104 over a wireless link via antenna 110. RF transceiver circuitry 108 performs functions similar to those of a radio network (RN) 128, including for example modulation/demodulation and possibly encoding/decoding and encryption/decryption. It is also contemplated that RF transceiver circuitry 108 may perform certain functions in addition to those performed by RN 128. It will be apparent to those skilled in art that RF transceiver circuitry 108 will be adapted to particular wireless network or networks in which mobile station 102 is intended to operate.

Mobile station 102 includes a battery interface 122 for receiving one or more rechargeable batteries 124. Battery 124 provides electrical power to electrical circuitry in mobile station 102, and battery interface 122 provides for a mechanical and electrical connection for battery 124. Battery interface 122 is coupled to a regulator 126 which regulates power to the device. When mobile station 102 is fully operational, an RF transmitter of RF transceiver circuitry 108 is typically turned on only when it is sending to network, and is otherwise turned off to conserve resources. Similarly, an RF receiver of RF transceiver circuitry 108 is typically periodically turned off to conserve power until it is needed to receive signals or information (if at all) during designated time periods.

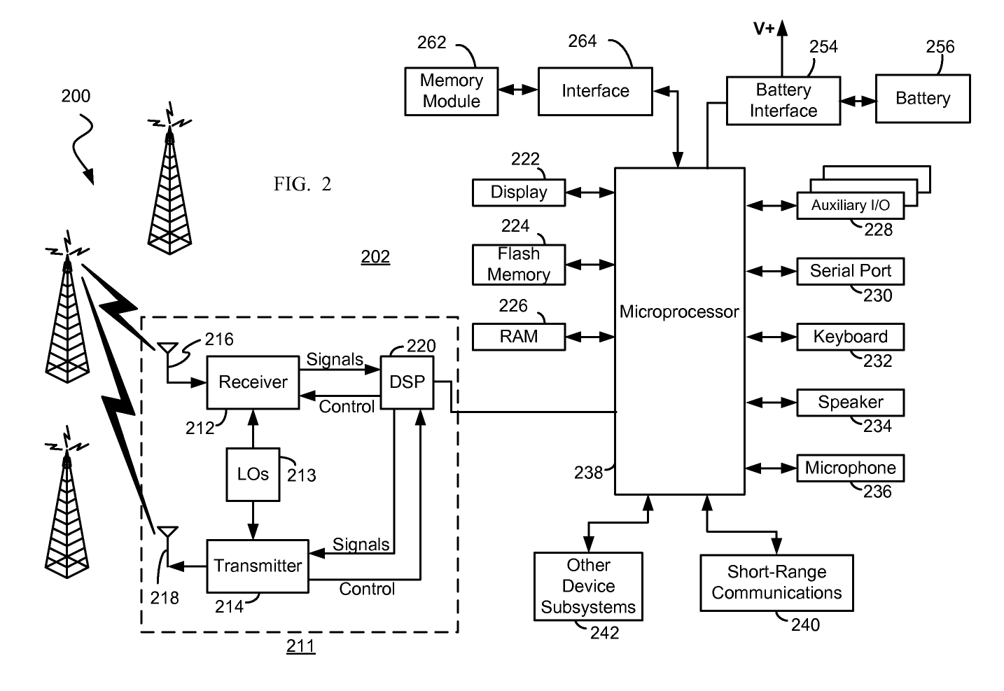

Mobile station 102 operates using a memory module 120, such as a Subscriber Identity Module (SIM) or a Removable User Identity Module (R-UIM), which is connected to or inserted in mobile station 102 at an interface 118. As an alternative to a SIM or an R-UIM, mobile station 102 may operate based on configuration data programmed by a service provider into an internal memory which is a non-volatile memory. Mobile station 102 may consist of a single unit, such as a data communication device, a cellular telephone, a multiple-function communication device with data and voice communication capabilities, a personal digital assistant (PDA) enabled for wireless communication, or a computer incorporating an internal modem. Alternatively, mobile station 102 may be a multiple-module unit comprising a plurality of separate components, including but in no way limited to a computer or other device connected to a wireless modem. In particular, for example, in the mobile station block diagram of FIG. 1, RF transceiver circuitry 108 and antenna 110 may be implemented as a radio modem unit that may be inserted into a port on a laptop computer. In this case, the laptop computer would include display 112, keyboard 114, and one or more auxiliary UIs 116, and controller 106 may remain within the radio modem unit that communicates with the computer's CPU or be embodied as the computer's CPU. It is also contemplated that a computer or other equipment not normally capable of wireless communication may be adapted to connect to and effectively assume control of RF transceiver circuitry 108 and antenna 110 of a single-unit device such as one of those described above. Such a mobile station 102 may have a more particular implementation as described later in relation to mobile station 202 of FIG. 2.

Mobile station 102 communicates in and through wireless communication network 104. In the embodiment of FIG. 1, wireless network 104 is a Third Generation (3G) supported network based on Code Division Multiple Access (CDMA) technologies. In particular, wireless network 104 is a CDMA2000 network which includes fixed network components coupled as shown in FIG. 1. Wireless network 104 of the CDMA2000-type includes a Radio Network (RN) 128, a Mobile Switching Center (MSC) 130, a Signaling System 7 (SS7) network 140, a Home Location Register/Authentication Center (HLR/AC) 138, a Packet Data Serving Node (PDSN) 132, an IP network 134, and a Remote Authentication Dial-In User Service (RADIUS) server 136. SS7 network 140 is communicatively coupled to a network 142 (such as a Public Switched Telephone Network or PSTN), whereas IP network is communicatively coupled to a network 144 (such as the Internet). Persons of ordinary skill in the art will appreciate that other networks and associated topologies including GPRS, E-GPRS and UMTS radio networks, among many others, may be employed with the teachings herein.

During operation, mobile station 102 communicates with RN 128 which performs functions such as call-setup, call processing, and mobility management. RN 128 includes a plurality of base station transceiver systems that provide wireless network coverage for a particular coverage area commonly referred to as a “cell”. A given base station transceiver system of RN 128, such as the one shown in FIG. 1, transmits communication signals to and receives communication signals from mobile stations within its cell. The base station transceiver system normally performs such functions as modulation and possibly encoding and/or encryption of signals to be transmitted to the mobile station in accordance with particular, usually predetermined, communication protocols and parameters, under control of its controller. The base station transceiver system similarly demodulates and possibly decodes and decrypts, if necessary, any communication signals received from mobile station 102 within its cell. Communication protocols and parameters may vary between different networks. For example, one network may employ a different modulation scheme and operate at different frequencies than other networks. The underlying services may also differ based on its particular protocol revision.

The wireless link shown in communication system 100 of FIG. 1 represents one or more different channels, typically different radio frequency (RF) channels, and associated protocols used between wireless network 104 and mobile station 102. An RF channel is a limited resource that must be conserved, typically due to limits in overall bandwidth and a limited battery power of mobile station 102. Those skilled in art will appreciate that a wireless network in actual practice may include hundreds of cells depending upon desired overall expanse of network coverage. All pertinent components may be connected by multiple switches and routers (not shown), controlled by multiple network controllers.

For all mobile stations 102 registered with a network operator, permanent data (such as mobile station 102 user's profile) as well as temporary data (such as mobile station's 102 current location) are stored in a HLR/AC 138. In case of a voice call to mobile station 102, HLR/AC 138 is queried to determine the current location of mobile station 102. A Visitor Location Register (VLR) of MSC 130 is responsible for a group of location areas and stores the data of those mobile stations that are currently in its area of responsibility. This includes parts of the permanent mobile station data that have been transmitted from HLR/AC 138 to the VLR for faster access. However, the VLR of MSC 130 may also assign and store local data, such as temporary identifications. Mobile station 102 is also authenticated on system access by HLR/AC 138. In order to provide packet data services to mobile station 102 in a CDMA2000-based network, RN 128 communicates with PDSN 132. PDSN 132 provides access to the Internet 144 (or intranets, Wireless Application Protocol (WAP) servers, etc.) through IP network 134. PDSN 132 also provides foreign agent (FA) functionality in mobile IP networks as well as packet transport for virtual private networking. PDSN 132 has a range of IP addresses and performs IP address management, session maintenance, and optional caching. RADIUS server 136 is responsible for performing functions related to authentication, authorization, and accounting (AAA) of packet data services, and may be referred to as an AAA server.

Wireless communication network 104 also includes a Push-to-talk over Cellular (PoC) server 137 which may be coupled to IP network 134. PoC server 137 operates to facilitate PoC individual and group communication sessions between mobile stations within network 104. A conventional PoC communication session involves a session connection between end users of mobile stations, referred to as session “participants”, who communicate one at a time in a half-duplex manner much like conventional walkie-talkies or two-way radios.

Those skilled in art will appreciate that wireless network 104 may be connected to other systems, possibly including other networks, not explicitly shown in FIG. 1. A network will normally be transmitting at very least some sort of paging and system information on an ongoing basis, even if there is no actual packet data exchanged. Although the network consists of many parts, these parts all work together to result in certain behaviours at the wireless link.

FIG. 2 is a detailed block diagram of a preferred mobile station 202. Mobile station 202 is preferably a two-way communication device having at least voice and advanced data communication capabilities, including the capability to communicate with other computer systems. Depending on the functionality provided by mobile station 202, it may be referred to as a data messaging device, a two-way pager, a cellular telephone with data messaging capabilities, a wireless Internet appliance, or a data communication device (with or without telephony capabilities). Mobile station 202 may communicate with any one of a plurality of base station transceiver systems 200 within its geographic coverage area.

Mobile station 202 will normally incorporate a communication subsystem 211, which includes a receiver 212, a transmitter 214, and associated components, such as one or more (preferably embedded or internal) antenna elements 216 and 218, local oscillators (LOs) 213, and a processing module such as a digital signal processor (DSP) 220. Communication subsystem 211 is analogous to RF transceiver circuitry 108 and antenna 110 shown in FIG. 1. As will be apparent to those skilled in field of communications, particular design of communication subsystem 211 depends on the communication network in which mobile station 202 is intended to operate.

Mobile station 202 may send and receive communication signals over the network after required network registration or activation procedures have been completed. Signals received by antenna 216 through the network are input to receiver 212, which may perform such common receiver functions as signal amplification, frequency down conversion, filtering, channel selection, and like, and in example shown in FIG. 2, analog-to-digital (A/D) conversion. A/D conversion of a received signal allows more complex communication functions such as demodulation and decoding to be performed in DSP 220. In a similar manner, signals to be transmitted are processed, including modulation and encoding, for example, by DSP 220. These DSP-processed signals are input to transmitter 214 for digital-to-analog (D/A) conversion, frequency up conversion, filtering, amplification and transmission over communication network via antenna 218. DSP 220 not only processes communication signals, but also provides for receiver and transmitter control. For example, the gains applied to communication signals in receiver 212 and transmitter 214 may be adaptively controlled through automatic gain control algorithms implemented in DSP 220.

Network access is associated with a subscriber or user of mobile station 202, and therefore mobile station 202 requires a memory module 262, such as a Subscriber Identity Module or “SIM” card or a Removable User Identity Module (R-UIM), to be inserted in or connected to an interface 264 of mobile station 202 in order to operate in the network. Alternatively, memory module 262 may be a non-volatile memory which is programmed with configuration data by a service provider so that mobile station 202 may operate in the network. Since mobile station 202 is a mobile battery-powered device, it also includes a battery interface 254 for receiving one or more rechargeable batteries 256. Such a battery 256 provides electrical power to most if not all electrical circuitry in mobile station 202, and battery interface 254 provides for a mechanical and electrical connection for it. The battery interface 254 is coupled to a regulator (not shown in FIG. 2) which provides power V+ to all of the circuitry.

Mobile station 202 includes a microprocessor 238 (which is one implementation of controller 106 of FIG. 1) which controls overall operation of mobile station 202. This control includes network selection techniques of the present application. Communication functions, including at least data and voice communications, are performed through communication subsystem 211. Microprocessor 238 also interacts with additional device subsystems such as a display 222, a flash memory 224, a random access memory (RAM) 226, auxiliary input/output (I/O) subsystems 228, a serial port 230, a keyboard 232, a speaker 234, a microphone 236, a short-range communications subsystem 240, and any other device subsystems generally designated at 242. Some of the subsystems shown in FIG. 2 perform communication-related functions, whereas other subsystems may provide “resident” or on-device functions. Notably, some subsystems, such as keyboard 232 and display 222, for example, may be used for both communication-related functions, such as entering a text message for transmission over a communication network, and device-resident functions such as a calculator or task list. Operating system software used by microprocessor 238 is preferably stored in a persistent store such as flash memory 224, which may alternatively be a read-only memory (ROM) or similar storage element (not shown). Those skilled in the art will appreciate that the operating system, specific device applications, or parts thereof, may be temporarily loaded into a volatile store such as RAM 226.

Microprocessor 238, in addition to its operating system functions, preferably enables execution of software applications on mobile station 202. A predetermined set of applications which control basic device operations, including at least data and voice communication applications, will normally be installed on mobile station 202 during its manufacture. A preferred application that may be loaded onto mobile station 202 may be a personal information manager (PIM) application having the ability to organize and manage data items relating to user such as, but not limited to, e-mail, calendar events, voice mails, appointments, and task items. Naturally, one or more memory stores are available on mobile station 202 and SIM 262 to facilitate storage of PIM data items and other information.

The PIM application preferably has the ability to send and receive data items via the wireless network. In a preferred embodiment, PIM data items are seamlessly integrated, synchronized, and updated via the wireless network, with the mobile station user's corresponding data items stored and/or associated with a host computer system thereby creating a mirrored host computer on mobile station 202 with respect to such items. This is especially advantageous where the host computer system is the mobile station user's office computer system. Additional applications may also be loaded onto mobile station 202 through network, an auxiliary I/O subsystem 228, serial port 230, short-range communications subsystem 240, or any other suitable subsystem 242, and installed by a user in RAM 226 or preferably a non-volatile store (not shown) for execution by microprocessor 238. Such flexibility in application installation increases the functionality of mobile station 202 and may provide enhanced on-device functions, communication-related functions, or both. For example, secure communication applications may enable electronic commerce functions and other such financial transactions to be performed using mobile station 202.

In a data communication mode, a received signal such as a text message, an e-mail message, or web page download will be processed by communication subsystem 211 and input to microprocessor 238. Microprocessor 238 will preferably further process the signal for output to display 222 or alternatively to auxiliary I/O device 228. A user of mobile station 202 may also compose data items, such as e-mail messages, for example, using keyboard 232 in conjunction with display 222 and possibly auxiliary I/O device 228. Keyboard 232 is preferably a complete alphanumeric keyboard and/or telephone-type keypad. These composed items may be transmitted over a communication network through communication subsystem 211.

For voice communications, the overall operation of mobile station 202 is substantially similar, except that the received signals would be output to speaker 234 and signals for transmission would be generated by microphone 236. Alternative voice or audio I/O subsystems, such as a voice message recording subsystem, may also be implemented on mobile station 202. Although voice or audio signal output is preferably accomplished primarily through speaker 234, display 222 may also be used to provide an indication of the identity of a calling party, duration of a voice call, or other voice call related information, as some examples.

Serial port 230 in FIG. 2 is normally implemented in a personal digital assistant (PDA)-type communication device for which synchronization with a user's desktop computer is a desirable, albeit optional, component. Serial port 230 enables a user to set preferences through an external device or software application and extends the capabilities of mobile station 202 by providing for information or software downloads to mobile station 202 other than through a wireless communication network. The alternate download path may, for example, be used to load an encryption key onto mobile station 202 through a direct and thus reliable and trusted connection to thereby provide secure device communication.

Short-range communications subsystem 240 of FIG. 2 is an additional optional component which provides for communication between mobile station 202 and different systems or devices, which need not necessarily be similar devices. For example, subsystem 240 may include an infrared device and associated circuits and components, or a Bluetooth™ communication module to provide for communication with similarly-enabled systems and devices. Bluetooth™ is a registered trademark of Bluetooth SIG, Inc.

Mobile station 202 may be adapted to provide instant messaging communications via programming instructions and data stored or otherwise available to the device 202 such as by way of an IM application. IM provides a conversational dialog typically involving the exchange of primarily text-based messages between a user of device 202 and at least one other user of another device (not shown) adapted for IM communication. As persons of ordinary skill in the art will appreciate, an IM system or “presence and instant messaging system” allows users to subscribe to each other and be notified of changes in state (e.g. availability for instant message communication) and for users to send each other short instant messages. IM is discussed in further detail in “RFC 2778—A Model for Presence and Instant Messaging”, maintained by the Internet Society and available at http://www.ietf.org/rfc/rfc2778.txt. As such, adapted mobile station 202 provides a user agent for IM communication in an IM system.

FIG. 10 illustrates components 1000, typically comprising program instructions and data that may be stored to flash memory 224 and/or RAM 226, for adapting station 202. Components 1000 comprise, broadly, graphical user interface (GUI) 1002, IM application 1004, IM contact list 1006, IM contact list entries for current conversations 1008, address book application 1010, address book contact data store 1011, current IM conversation messages 1014, and IM contextual menu buffers 1016. IM application component 1004 provides presence and IM communication functions for the user (e.g. a user having the name of “Sarah”) of the mobile station 202.

Often, IM applications are provided as standalone applications separate from other communication applications on device 202 such as separately from email applications or phone applications, etc. The IM application maintains a contact list (often with the assistance of a remote IM server (not shown)) that is separate from an address book of contact information that may be otherwise available to device 202 via an address book interface and which address book is typically integrated with the device's email and/or phone application. As such, IM contact information is not usually stored in the address book and most address book contact information is not maintained in the contact list.

In order to invite another user to be an IM contact of the user of device 202, the other user's email address is often supplied to the IM application by the IM user of device 202 to send the invitation. However, another data message address, such as a PIN, could also be used instead. Thus the IM contact list can store a non-IM address for an IM contact.

Advantageously, as described further below, the IM application and address book may be adapted so that the IM application can obtain address book information for an IM contact with which the IM application can then present context sensitive options for a user to invoke other communication abilities with the IM contact.

GUI 1002 provides support for a contact list oriented interface for controlling aspects of the presence and IM functions using list of IM contacts 1006. Additional IM contact list entries may include entries for current conversations 1008. Other IM contact list entries may include IM group entries for organizing individual IM contacts, and pending or unavailable IM contacts in accordance with presence information (not shown in FIG. 10).

Address book application 1010 manages address book contact information. Address book application 1010 usually provides user access to contact data store 1011 to update or maintain such information and provides API access to email or other communication applications to obtain contact information with which to respectively communicate with the contact. Contact data store 1011 stores the contact records 1012. Typically, a contact record may contain contact information such as a contacts name, title and company, email addresses, phone numbers (e.g. one or more for home, work, fax, pager, etc.) mailing addresses, PIN (i.e. a personal identification number for a user's mobile station within a particular service provider network), etc. Some service provider's permit data messaging using PIN addressing.

Address book application 1010 provides an interface that permits other applications to retrieve information from contact data store 1011. Contact data store 1011 may employ various storage schemes (e.g. plain text or binary data) for contact records 1012. Data compression may also be applied to contact records stored in the contact data store.

Persons of ordinary skill in the art will appreciate that IM Application 1004 may, in some embodiments, directly access the contact data store 1011 in order to decrease the search time or to avoid interacting with the address book application 1010 among other reasons obvious in the art. When there is direct access to the contact data store 1011, precautions may have to be taken to prevent multiple applications from simultaneously accessing and corrupting the contact data store.

In accordance with the present matter, contextual menus 1016 may be created by the system and method for adding address book verbs to the IM application menus. As such, the GUI 1002 may use the contextual menu containing the user selected IM contact's relevant address book verbs as part of the IM application menus.

As will be understood by those of ordinary skill in the art, it is sometimes difficult to make bright-line distinctions between components such as, GUI, IM application and contextual menu components 1002, 1004 and 1016 or address book application 1010 and contact data store 1011. As well, it is understood that the components 1000 interface with other such components (not shown) on or for mobile station 202 such as operating system, communication sub-system, PIM components, etc.

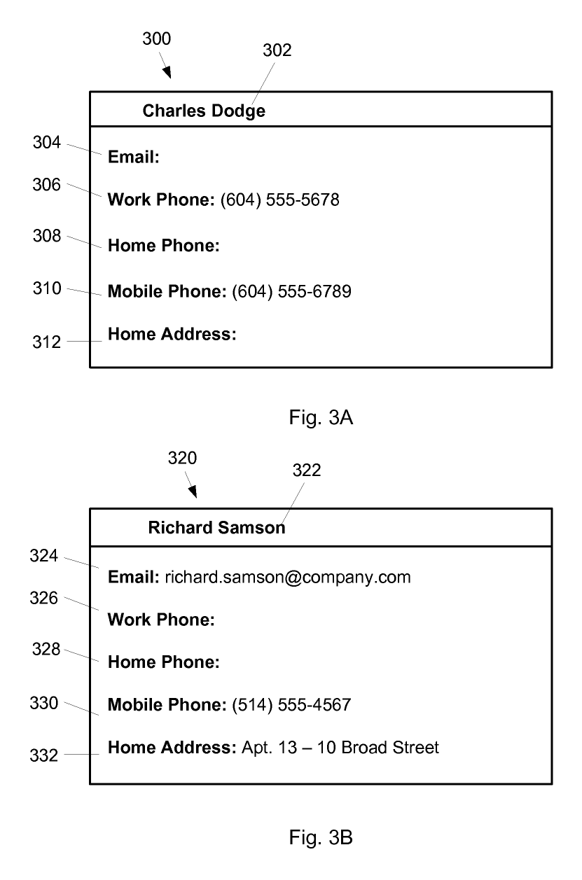

FIG. 3A illustrates a representative view 300 of a address book contact information screen provided by a address book GUI of address book application 1010. View 300 includes a title portion 302 showing the contact's name and presents contact information such as email address 304, work phone number 306, home phone number 308, mobile phone number 310 and a home mailing address 312. It will be understood that 304, 306, 308, 310, and 312 are examples of contact information and contact records 1012 may include other types of contact information. In the present example, the contact information for “Charles Dodge” comprises work and mobile phone numbers and blank entries for email and home phone number and home address.

FIG. 3B illustrates a second representative view 320, similar to view 300, of a contact information screen for “Richard Samson”. View 320 comprises an email address 324, mobile phone number 330, home address 332 and blank entries for work phone number 326 and home phone number 328.

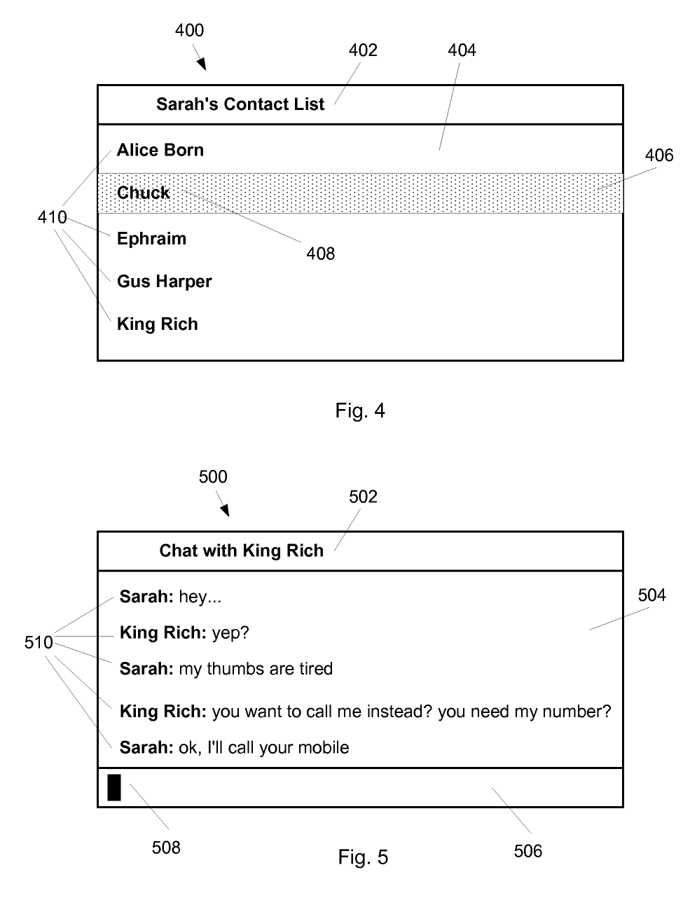

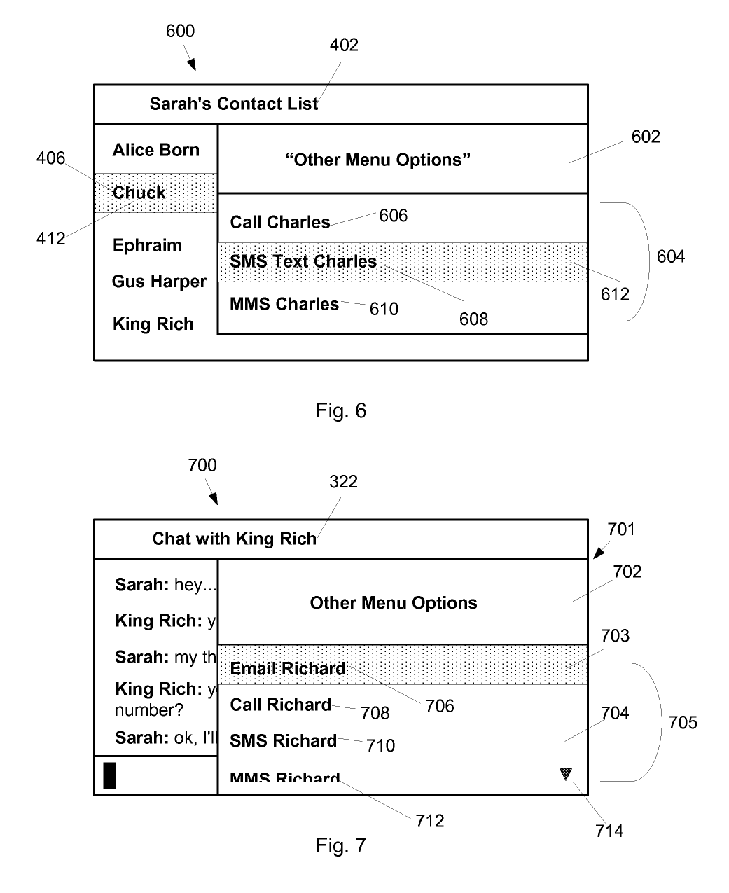

FIG. 4 illustrates a representative view 400 of an IM screen provided by a GUI 1002 for an IM application 1004. View 400 includes a title portion 402 showing “Sarah's Contact List” and presents a contact list 404 with contact list entries 410, and GUI focus 406. View 400 of Sarah's Contact List may be traversed by a user by moving a focus 406 about the view to interact with various elements of the GUI such as the individual contact list entries 410. Focus 406 may be indicated in various ways such as by reverse video mode, etc. Traversal or other navigation may be facilitated by input devices such as arrow keys, trackwheel, trackball, pointing device, etc. Once a particular element is selected by a user of the mobile station 202, particular command options may be invoked. Options may be presented via one or more menus or invoked through predefined keystrokes etc. common in the art. Entries in the contact list 404 may be navigated such as by moving the focus 406 up and down the screen. Specific contacts may be selected to invoke a contextual GUI menu. In this example, contact list entry “Chuck” 408 has been selected by the user with focus 406 and when activated (whether by a menu interface or by clicking an enter key for example) invokes a view (e.g. 600 of FIG. 6) of GUI 1002 for a contextual menu with address book verbs added.

FIG. 5 illustrates a representative IM view 500 of a current conversation 510 with contact “King Rich” and comprises a title portion 502 for indicating the contact and a message-history portion 504 for showing an exchange of messages. A message-composition portion 506 with a cursor 508 is also provided with which to compose IM messages to the contact. In accordance with this embodiment, the user may invoke (whether by a menu interface or by clicking a menu key for example) a view (e.g. 700 of FIG. 7) of GUI 1002 for a contextual menu with address book verbs added.

FIG. 6 illustrates a view 600 of a menu invocation manner for invoking an alternate communication ability from the IM contact list GUI 1002 showing the IM contact list 404 of FIG. 4 as an example. View 600 shows a menu 603 comprising a list of user options including a contextual menu portion 604, and a portion for other menu options 602, the details of which options 602 are not shown. Context menu portion 604, comprising one or more address book verbs for invoking alternative communications with the IM contact, need not be shown at the end of the options list. However, these options are preferably grouped for ease of understanding and location in the list. A focus 612 may be moved to navigate the options list in menu 603. In the present example, alternate communication abilities for IM contact “Chuck” comprise placing a phone call 606, sending a Short Message Service (SMS) text message 608 and sending a Multimedia Message Service (MMS) message 610 based on the associated address book information located for the IM contact “Chuck”.

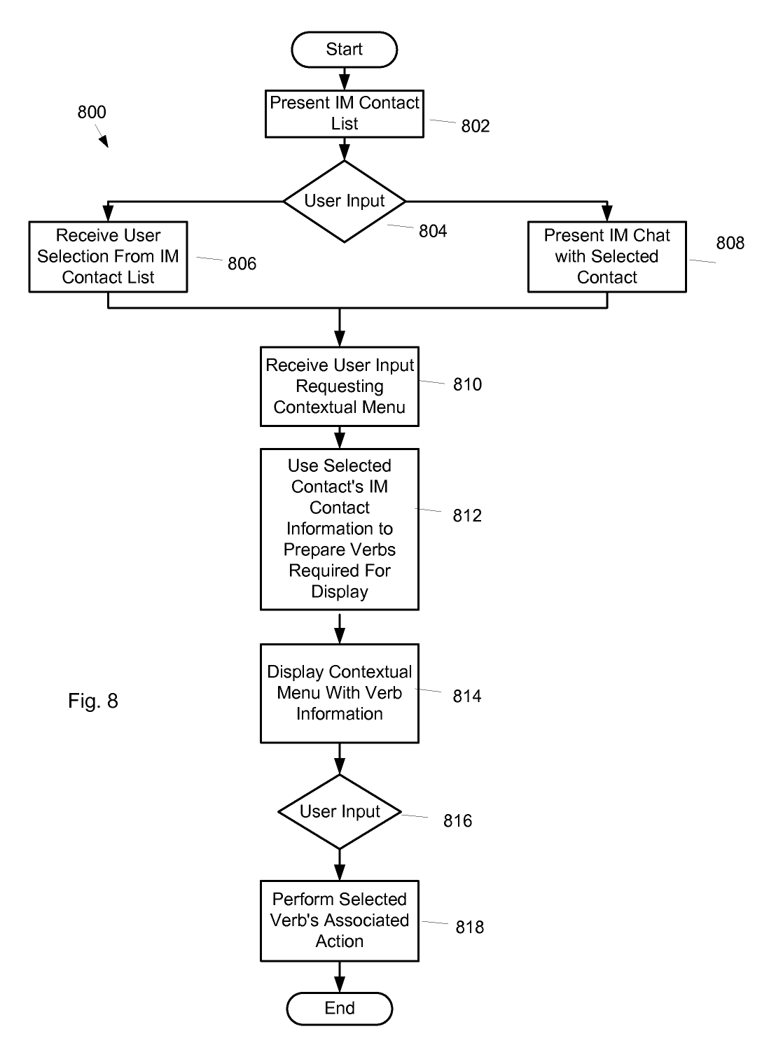

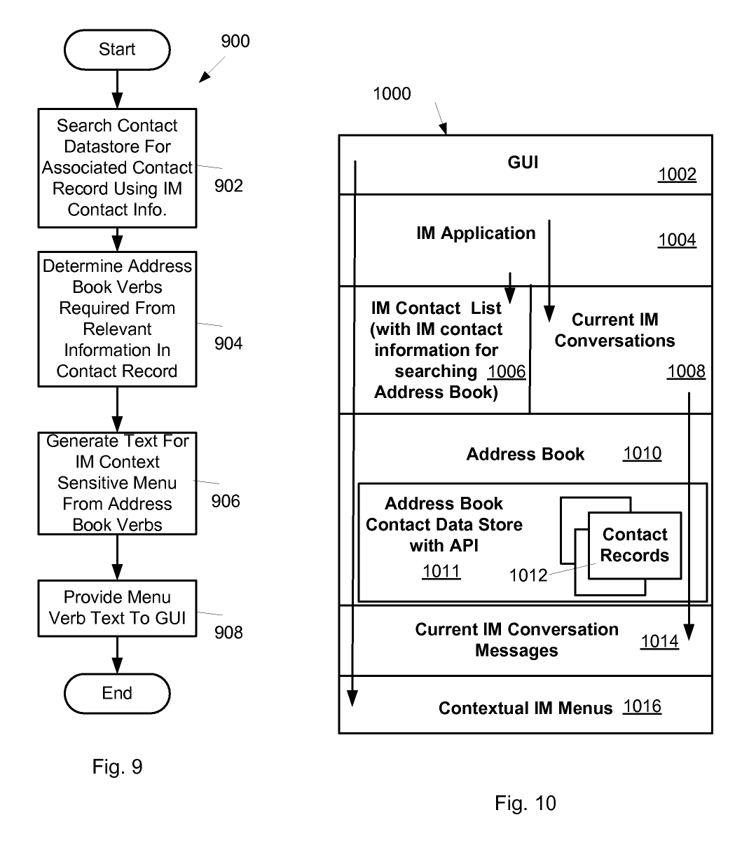

Contextual menu 604 is invoked by moving the focus 406 to designate the contact, in this example, “Chuck” 412. Menu options 606, 608, 610 in the contextual menu 604 may be navigated such as by moving the focus 612 up and down the screen. Menu options 606, 608 and 610 are generated from the associated contact information 304 to 310 for the IM contact 312 using the system and method for adding address book verbs to the IM application menus described further herein below (see FIGS. 8 and 9). Persons of ordinary skill in the art will appreciate that other menu options 602 may contain entries generated by the GUI 1002 or IM application 1004 for other actions relevant to control of the GUI or IM contact list 404 (e.g. ‘Start Conversation’ ‘Add a Contact . . . ’, ‘Contact Info’, etc.).

Generally, it is possible to associate an action verb or address book verb that represents a communication ability with an associated contact information entry, e.g. 304 to 312. As will be understood by those of ordinary skill in the art, communication devices such as a mobile phone may support multiple communication abilities and multiple action verbs may be associated with each ability. For example, contact information such as a mobile phone number can be associated with the action or address book verbs “Call”, “SMS Text”, and “MMS”.

In this example, menu option “Call Charles” 606 consists of an address book verb “Call” which is associated with one or more phone numbers in the contact information (e.g. 306 and 310) and the IM contact's first name “Charles” from 302. Menu option “SMS Text Charles” 608 and “MMS Charles” 610 consists of the address book verbs “SMS Text” and “MMS” which is associated with the mobile phone number contact information 310 and the IM contacts first name “Charles” from 302. Contact information entries 304 and 308 are empty and do not generate a corresponding entry in the contextual menu 602.

FIG. 7 illustrates a view 700 of a menu invocation manner for invoking an alternate communication ability from the conversation GUI 1002 using the current IM conversation of FIG. 5 as an example. View 700 includes a menu 701 having a contextual menu portion 705, other menu options 702, focus 703, GUI navigational element 714 and in this example alternate communication abilities for IM contact “King Rich” consisting of sending an email 706, placing a phone call 708, sending a SMS text message 710 and sending a MMS message 712.

Navigational element 714 indicates that additional contextual menu entries may appear off screen below. Menu options 706, 708, 710 and 712 are generated from the associated address book contact information 324, 330 and 332 for the IM contact 322 using the system and method for adding address book verbs to the IM application menus describe below (see FIGS. 8 and 9). Identification of the IM contact “King Rich” 332 is implicit because the IM conversation 510 is between “Sarah” and “King Rich”. Other menu options 702 may contain entries generated by the GUI 1002 or IM application 1004 for other actions relevant to control of the GUI or particular IM conversation. In this example, menu options 706, 708, 710 and 712 are generated as per the method described above for 606, 608 and 610 except that the contact's first name is “Richard” 322. Contact information entries 326 and 328 are empty and do not generate a corresponding entry in the contextual menu 704.

FIG. 8 illustrates operation 800 of IM application 1004 for a system and method for adding address book verbs to the IM application menus, for example, to enable a convenient interface to switch to an alternate available communication ability with an IM contact.

Operations 800 provide a general overview of the actions required for adding address book verbs to the IM application menus. In the example of FIG. 8, the operations 800 represent steps for a user to invoke a contextual menu containing the relevant address book verbs from within the IM application. The contextual menu may be invoked from the IM contact list (view 400) or from an IM conversation (view 500). Persons of ordinary skill in the art will appreciate that the IM contact may have to perform corresponding actions to accept the alternate incoming communication.

At step 802, the user is presented with a contact list view (e.g. view 400) by GUI 1002 upon starting the IM application 1004. Operations 800 in response to certain pre-requisite user input such as menu driven commands or predetermined keystrokes, etc. (step 804) may branch to perform respective operations. In the simplified view, there is shown step 806 for selecting a particular IM contact from the contact list 1006 and step 808 for starting an IM conversation with an IM contact selected from the contact list 1006.

From the IM contact information, the initial email or other address used for the buddy invitation or, possibly, the contact's name is available to the IM application 1004 through user selection of the contact (step 806) or from the IM conversation window with the IM contact (step 808). In response to user input invoking the display of the contextual menu (step 810) the associated IM contact information (e.g. email address) can be used to find an address book contact record 1012 in the contact data store 1011 to prepare the address book verbs required (step 812). Step 812 is further described as operations 900 in FIG. 9. In one embodiment, GUI 1002 will use the address book verbs prepared by IM application 1004 (step 812) in the display of the contextual menu (step 814). In another embodiment, GUI 1002 will use the address book verbs prepared by the address book application 1010 in the display of the contextual menu. The user may use the contextual menu interface to select another communication ability as represented by the address book verb (step 816). GUI 1002 will invoke the selected address book verb's associated action (step 818). Persons of ordinary skill in the art will appreciate that further operations may be performed when invoking a communication ability. For example, though not illustrated, if ‘Email “contact”’ is invoked, the associated email application is invoked to present an email composition interface for the user. It may be necessary to select among more than one stored email address in the address book for the contact so that the recipient “To:” addressee can be populated with the desired email address of the contact. The email is then composed and sent by the user of device 202. Similar operations my apply for ‘Call “contact”’. While the alternative communication operations are performed, IM application 1004 may continue to operate in the background. Though not illustrated in FIG. 8, persons of ordinary skill in the art will appreciate that once these alternative communication operations are finished, operations of IM application 1004 may return to the foreground automatically.

FIG. 9 illustrates operations 900 of IM application 1002 and address book application 1010 for finding and preparing the selected IM contact's address book verb information for display (step 812) from available address book contact information. Operations 900 provide a general overview of step 812.

In one embodiment, an API for the address book application 1010 is provided to the IM application to pull information, invoking a search of the contact data store 1011 for the contact record 1012 associated with the selected IM contact (step 902). The particular address book contact record 1012 is then examined to determine which contact information entries are available. The respective associated information is provided to the IM application to create the context sensitive menu portion (e.g. 604 or 705). At step 904 it is determined which address book verbs are to be used (step 904). Some address book contact information (e.g. a phone number) will provide multiple communication abilities (e.g. phone and SMS) that require multiple address book verbs. At step 906, text for the contextual menu 1016 is generated from mapping each required contact information entry to the appropriate address book verb (i.e. action). Contextual menu text with the address book verbs is then passed to the GUI 1002 (step 908). In one embodiment, the IM application 1004 performs the steps 902, 904, 906 and 908 as described. Persons of ordinary skill in the art appreciate that different criteria may be used in determining what contact information is relevant, for example, whether the entry is completed or if the communication method is currently available. Those of ordinary skill in the art will also understand that there may not be a bright-line distinction between steps 904 and 906 and that the steps may be combined and performed together.

Various storage schemes (e.g. linked lists) and memory allocation schemes for current IM conversations 1008, current conversation messages 1014 and contextual menus 1016 may be employed. Particular contextual menus 1016 may be linked to the GUI 1002 via pointers or other known techniques for associating one structure with another.

While discussed with reference to a handheld mobile device such as a smart PDA or smart phone, IM applications may be implemented on other computing devices such as personal computers (laptops, desktops), workstations and the like configured for network communications. IM applications and IM games are commercially available (e.g. AIM™ from AOL, Yahoo! Messenger™, MSN Messenger™, etc.) for many platforms such as PCs with various Windows® or Windows compatible operating systems with sufficient memory and video capabilities. Additional software requirements may include an Internet browser and plug-ins and support for Java (e.g. JVM or plug-in support) as well as an available Internet connection.

Advantageously, alternative data communication capabilities other than IM using the same IM application can be invoked as well as voice communications from the IM application interface. Such reduces keystrokes or other user input and takes advantage of address book contact information that can be centrally maintained for use by different applications.

The above-described embodiments are intended to be examples only. Those of skill in the art may effect alterations, modifications and variations to the particular embodiments without departing from the scope of the application. The subject matter described herein in the recited claims intends to cover and embrace all suitable changes in technology.

We claim:

1. A method of communicating with an Instant Messaging (IM) contact using a communication device comprising an IM application, one or more alternative communication applications and an address book storing address book contact information for communicating using said alternative communication applications, said method comprising:
in an user interface of the IM application, providing a context sensitive menu of options for invoking respective alternative communication abilities of the communication device to communicate with the IM contact, said context sensitive menu of options comprising one or more actions associated with the alternative communication applications as determined from available address book contact information for the IM contact;
receiving user input selecting a particular action; and
invoking the alternative communication application with the respective address book contact information.

2. The method of claim 1 comprising:
storing IM contact information for an IM contact list of the IM application; and
using at least some of said IM contact information to obtain the address book contact information from the address book.

3. The method of claim 2 wherein said address book provides an application programming interface to retrieve address book contact information from IM contact information.

4. The method of claim 3 wherein the IM contact information comprises an email address for the IM contact and wherein said address book provides address book contact information using email addresses.

5. The method of claim 3 comprising determining specific actions for the context sensitive menu in response to available address book contact information provided from the address book.

6. The method of claim 1 wherein the alternative communication abilities comprise at least one of: (i) data communication capabilities other than IM using the IM application; and (ii) voice communication capabilities.

7. The method of claim 5 wherein the data communication capabilities comprise at least one of email, SMS and MMS and said address book is configured to store respective data communication address information for sending respective data communications.

8. A communication device for communicating Instant Messaging (IM) messages with IM contacts, said device comprising a processor and memory storing instructions and data for execution by the processor, said instructions and data defining an IM application, at least one alternative communication application and an address book comprising address book contact information for communicating using said at least one alternative communication application, said instructions and data configuring the processor for:
providing, in an user interface for communicating IM messages, a context sensitive menu of options for invoking respective alternative communication abilities of the communication device to communicate with the IM contact, said context sensitive menu of options comprising at least one action associated with alternative communication applications as determined from available address book contact information for the IM contact;
receiving user input selecting a particular action; and
invoking the alternative communication application with the respective address book contact information.

9. The communication device of claim 8 wherein the instructions and data configure the processor for:
storing IM contact information for an IM contact list of the IM application; and
using at least some of said IM contact information to obtain the address book contact information from the address book.

10. The communication device of claim 9 wherein said address book provides an application programming interface to retrieve address book contact information from IM contact information.

11. The communication device of claim 10 wherein the IM contact information comprises an email address for the IM contact and wherein said address book provides address book contact information using email addresses.

12. The communication device of claim 10 wherein the instructions and data configure the processor for determining specific actions for the context sensitive menu in response to available address book contact information provided from the address book.

13. The communication device of claim 8 wherein the alternative communication abilities comprise at least one of: (i) data communication capabilities other than IM using the IM application; and (ii) voice communication capabilities.

14. The communication device of claim 13 wherein the data communication capabilities comprise at least one of email, SMS and MMS and said address book is configured to store respective data communication address information for sending respective data communications.

15. A computer program product comprising a computer readable medium carrying instructions and data for execution in a processor of communication device in accordance with claim 8.
